(19) United States
(12) Patent Application Publication
(10) Pub. No.: US 2012/0297741 A1
(43) Pub. Date: Nov. 29, 2012

(54) OPEN TOP WORK CELL HAVING A FLUID BARRIER

(76) Inventors: John Reid, Royal Oak, MI (US); Jerry Douglas, Sterling Heights, MI (US)

(21) Appl. No.: 13/480,144

(22) Filed: May 24, 2012

Related U.S. Application Data
(60) Provisional application No. 61/489,896, filed on May 25, 2011.

(51) Int. Cl. B01D 46/00; B23P 11/00

(52) U.S. Cl. 55/385.2; 137/15.01

(57) ABSTRACT

A work cell assembly such as welding cell assembly and a method for assembling the same is provided. The work cell has a perimeter wall including an upper wall edge defining an open top. A fluid filtration unit draws in fluid from the work cell and removes contaminants. A fluid moving device including an air blade assembly adjacent the upper wall edge and an inlet adjacent the upper wall edge and spaced downstream from the air blade assembly establish therebetween a sheet-like fluid barrier extending across the open top. The fluid barrier is defined by a continuous flow of fluid traveling across the open top for entraining the contaminant and creating a ceiling effect across the open top to prevent escape of the contaminant from the work cell through the open top. The fluid barrier has a narrow vertical extent to prevent disturbance of the fluid in the work cell.

### CROSS REFERENCE TO RELATED APPLICATION

This application claims the benefit of application Ser. No. 61/489,896 filed May 25, 2011.

### BACKGROUND OF THE INVENTION

1. Field of the Invention

The subject invention generally relates to a work cell assembly containing a contaminant suspended in a fluid and a method for assembling the same. More specifically, the subject invention relates to a welding cell assembly enclosing air and welding operation exhaust gases and a method for assembling the same.

2. Description of the Prior Art

It is well known that certain manufacturing operations create exhaust gases that require filtration. The assignee of the present application is in the field of air filtration and manufacturers numerous systems to filter exhaust gases created in manufacturing operations.

A typical application for the filtration of exhaust gases is in manufacturing operations conducted within work cells, such as for example welding operations and in particular in welding operations conducted in “weld cells”. Such work cells commonly include a perimeter wall surrounding and enclosing a work area containing air and welding operation exhaust gases. The perimeter wall includes an upper wall edge defining a top and a bottom wall edge circumscribing a floor area. A roof extends across the top thereby isolating or sealing the fluid contained within the work cell from the external environment of the plant, factory, or job site.

The perimeter wall of conventional work cells are often defined by four wall sections including a pair of side walls and a pair of end walls spaced from one another by the side walls. A fluid filtration unit is connected to the work cell for filtering the air contained within the work cell. The fluid filtration unit typically has at least one filter element and a fan for drawing the air and exhaust gases contained in the work area through the filter element to remove the welding operation exhaust gases from the work area. The filtered air may then be returned to the work area. The method generally used to assemble such work cells generally includes the steps of erecting a perimeter wall surrounding and enclosing the work area and installing a fluid filtration unit for removing the contaminant from the fluid and returning the fluid to the work area.

Many weld cells require access through an opening in the top of the cell to insert or remove equipment by hoists. This opening normally takes the form of a channel that can receive a hoist that slides in and out of the cell. The channel is sealed in some manner to prevent the egress of exhaust fumes. One example is the use of opposed brushes in the channel to engage the hoist and seal against the egress of exhaust fumes. However, the use of a channel to allow the insertion or removal of equipment into and out of the work cell is inherently a problem in certain large welding operations or with certain heavier of larger pieces of equipment.

What is needed is a way to insert the equipment into the top of the weld cell. It is known to retract the roof, but this has disadvantages. It requires a weld cell that has a retractable roof and it takes time to retract and then close the roof each time that equipment is to be inserted. Another less desirable approach is to remove the roof of the weld cell each time a piece of equipment is to be inserted or removed. Again, this is time consuming and not a truly desirable solution. Inserting equipment through the sides of the weld cell is also problematic since the sides have to be removed and there is usually limited room inside a plant to allow the maneuvering of large pieces of equipment. Most plants move large equipment by roof mounted hoists on tracks that can easily move equipment above the floor of the plant.

What is needed is an open top on a weld cell. However, this creates a problem in that the exhaust gases are able to escape thought the open top with conventional filtering systems.

Prior art devices have been produced that utilize air currents to contain contaminants in a work area. One such device is disclosed in U.S. Pat. No. 4,856,419 to Imai and includes a dust collection hood having peripheral channels that direct an annular air flow curtain downwardly around a contaminated surface. At the same time, the contaminant is collected by a center channel that produces an upwardly directed suction gas flow within the annular air flow curtain. Accordingly, the Imai design includes two opposing air flows arranged to collect the contaminant. While the annular air flow curtain of the Imai design eliminates the need for a perimeter wall, the opposing air flows created make the Imai design ill suited for use in welding operations. The upwardly directed suction gas flow disposed within the downwardly directed annular air flow curtain would suck the shielding gases away from the work piece resulting in poor weld quality. Along the same lines, as the annular air flow curtain strikes the contaminated surface, the annular air flow curtain must split into a pair of turbulent air currents extending outwardly and inwardly along the contaminated surface. The inwardly directed air current would further disturb the shielding gases used in welding operations. The Imai design is also at odds with the roof mounted hoists used at most plants as the dust collection hood gets in the way of vertically lifting equipment and work pieces from the work area.

Accordingly, what is needed is a work cell assembly that allows for the unfettered vertical lifting of equipment and work pieces out of the work cell while preventing the escape of contaminants from the work cell. At the same time, the work cell assembly must prevent the disturbance of the fluid contained in the work area so as to accommodate the use of shielding gases in welding operations conducted within the work cell.

### SUMMARY OF THE INVENTION

The work cell assembly of the subject invention includes a fluid moving device establishing a sheet-like fluid barrier extending across the open top of the work cell. The fluid barrier is defined by a continuous flow of fluid traveling across the open top of the work cell. The fluid barrier entrains the contaminant contained in the work area and creates a ceiling effect across the open top of the work cell to prevent escape of the contaminant from the work area through the open top. The fluid barrier also has a narrow vertical extent to prevent disturbance of the fluid contained within the work area.

The method for assembling the work cell of the subject invention includes the step of establishing a sheet-like fluid barrier across the open top of the work cell. This step includes establishing a fluid barrier defined by a continuous flow of fluid traveling across the open top for entraining the contaminant and creating a ceiling effect across the open top to prevent escape of the contaminant from the work area through the open top. This step further includes establishing a fluid barrier having a narrow vertical extent to prevent disturbance of the fluid contained in the work area.

### Advantages of the Invention

The present invention solves the problem of conventional work cells and in particular weld cells by providing a work cell that has an open top and prevents the escape of contaminants from the work cell. According to this open top configuration, equipment and work pieces can be loaded into the work cell or extracted therefrom using lifting equipment disposed above the work cell. This can all be done quickly and easily without the need for removal of roof panels or similar structure associated with prior art designs. Moreover, the sheet-like fluid barrier that provides these benefits has a narrow vertical extent that prevents the disturbance of the fluid contained in the work area below. Accordingly, the work cell of the subject invention can be used in applications requiring welding operations that use shielding gases to prevent oxidation in the weld area.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an exemplary work cell assembly;

FIG. 2 is another perspective view of the exemplary work cell assembly;

FIG. 3 is a side elevation view of the exemplary work cell assembly shown with one of the side walls removed;

FIG. 4 is a top elevation view of the exemplary work cell assembly;

FIG. 5 is another side elevation view of the exemplary work cell assembly;

FIG. 6 is a front elevation view of the exemplary work cell assembly; and

FIG. 7 is a fragmentary cross-sectional view of an exemplary fluid moving device and fluid barrier of the work cell assembly.

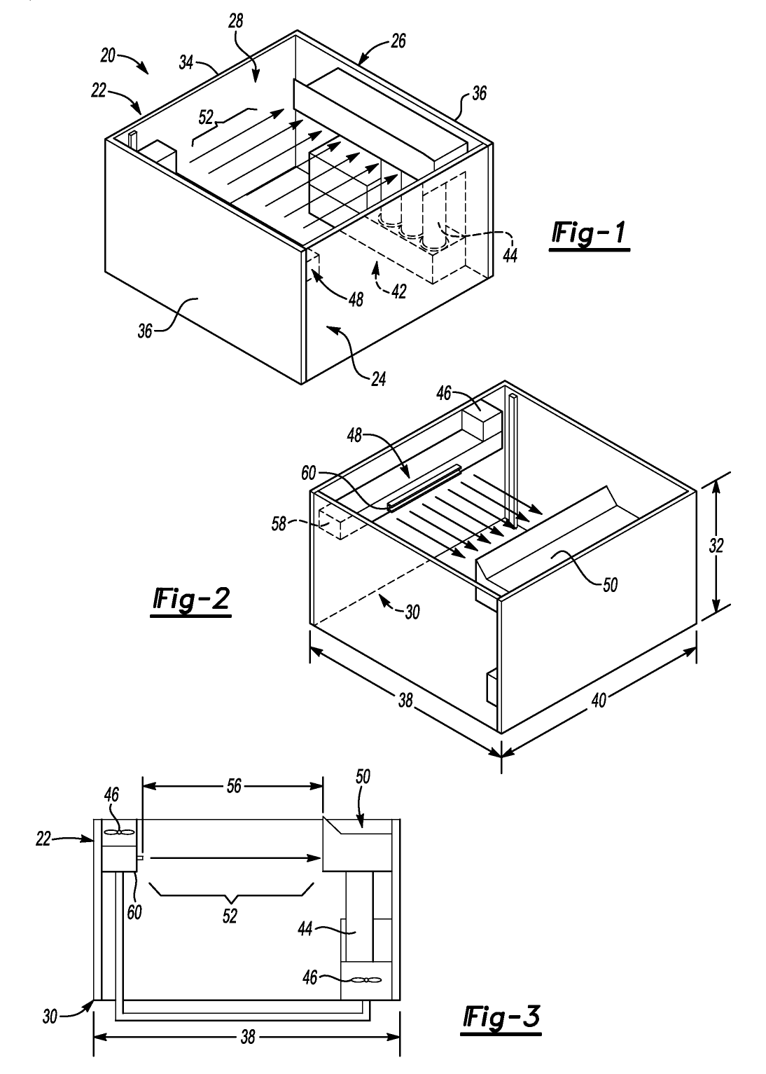

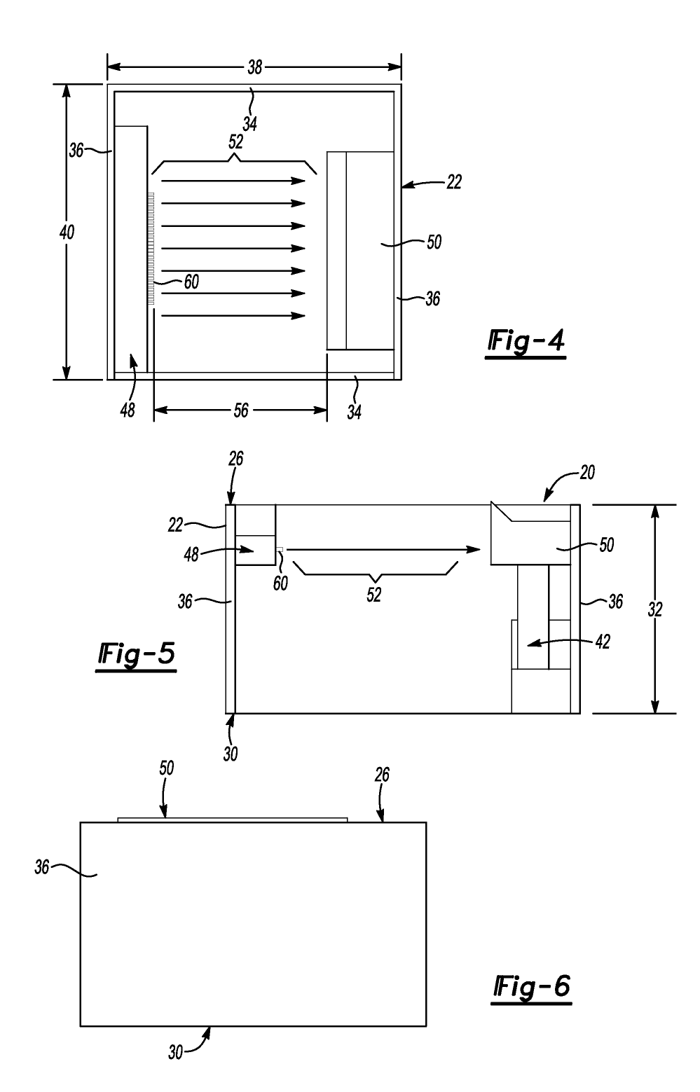

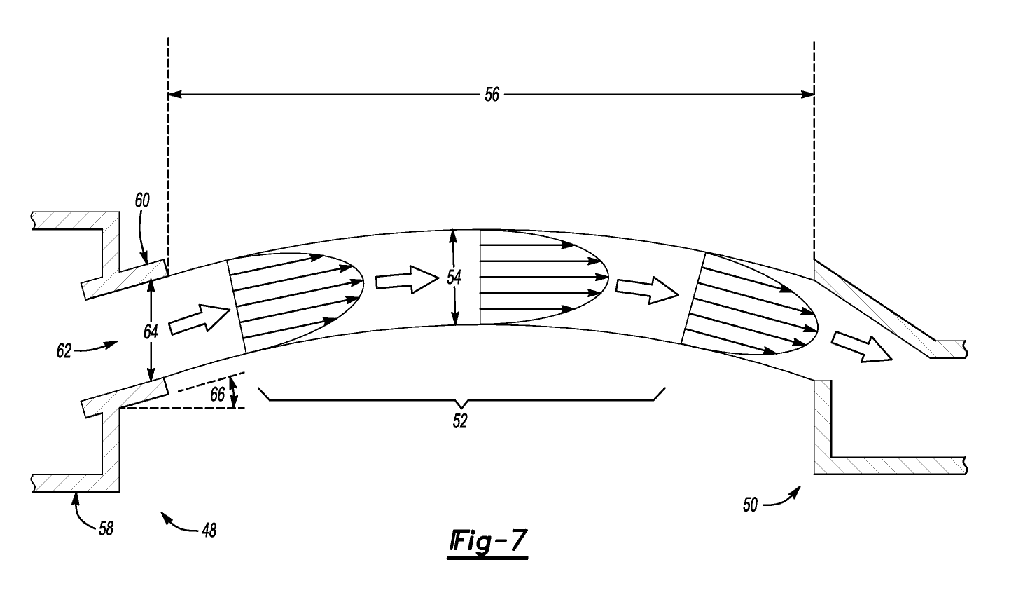

### DETAILED DESCRIPTION OF THE ENABLING EMBODIMENTS

Referring to the Figures, wherein like numerals indicate corresponding parts throughout the several views, a work cell 20 assembly containing a contaminant suspended in a fluid is provided. It should be appreciated that the work cell 20 for example may take the form of a welding cell 20 containing welding operation exhaust gases suspended in air.

The work cell 20 includes a perimeter wall 22 surrounding and enclosing a work area 24. There is no ceiling on the work cell 20. The work area 24 represents a volume containing the fluid and the suspended contaminant. The work area 24 also refers to the area where manufacturing operations are carried out in an environment sealed off from the rest of the factory or job site. It should be appreciated that such manufacturing operations often generate exhaust gases requiring filtration. In the case of welding, the operator works within the weld cell 20. Accordingly, the welding equipment and the work piece being welded are also disposed within the work area 24 of the welding cell 20.

The perimeter wall 22 includes an upper wall edge 26 defining an open top 28 open to the factory or the job site. According to this open top 28 configuration, equipment and work pieces can be loaded into the work cell 20 or extracted therefrom using lifting equipment disposed above the work cell 20. The perimeter wall 22 further includes a bottom wall edge 30 circumscribing a floor area. It should be appreciated that the distance measured between the upper wall edge 26 and the lower wall edge equals a height 32 of the work cell 20. The perimeter wall 22 may be defined by four wall sections including a pair of side walls 34 and a pair of end walls 36 spaced from one another by the side walls 34. Accordingly, the work cell 20 may be generally square or rectangular in shape. The side walls 34 further define a length 38 of the work cell 20 and the end walls 36 further define a width 40 of the work cell 20. It should be appreciated that the work cell 20 is not limited to four sided shapes but may take the form of a triangle, a pentagon, or a variety of other shapes.

The work cell 20 may include a fluid filtration unit 42 to remove contaminants from the fluid contained in the work area 24. The fluid filtration unit 42 may have at least one filter element 44 and a fan 46 for drawing the fluid and the contaminants through the filter element 44. After the contaminants have been removed from the fluid passing through the filter element 44, the fluid may be returned to the work area 24. Alternatively, the fluid may be exhausted into the factory or job site after passing through the filter element 44.

The work cell 20 further includes a fluid moving device 48, 50 establishing a sheet-like fluid barrier 52 extending longitudinally across the open top 28 to cover it. The fluid barrier 52 is defined by a continuous flow of fluid traveling across the open top 28. In other words, the fluid barrier 52 is a continuously moving layer of fluid extending across the open top 28 of the work cell 20. As the contaminants suspended in the fluid in the work cell 20 rise, the contaminants, such as welding operation exhaust gases, become entrained in the fluid barrier 52. Accordingly, the fluid barrier 52 creates a ceiling effect across the open top 28 to prevent escape of the contaminants from the work area 24 through the open top 28 and to move the contaminants to the fluid filtration unit 42. The sheet-like fluid barrier 52 has a narrow vertical extent 54 to prevent disturbance of the fluid contained in the work area 24. In other words, the continuously moving layer of fluid forming the fluid barrier 52 has a limited vertical thickness that is substantially less than the height 32 of the work cell 20. In the preferred embodiment, the vertical thickness is only a few inches in the proximity of the fluid moving device 48 and then can widen across the length 38 of the work cell 20. In this way, the moving fluid of the fluid barrier 52 does not disturb the fluid contained in the work area 24.

It should be appreciated that the ability to provide a fluid barrier 52 without disturbing the fluid in the work area 24 is important where the work cell 20 is being used as a welding cell 20. Welding operations often require the use of gas shielding to prevent oxidation in the weld area. Gases such as helium or argon are often used in this application. Accordingly, if the fluid barrier 52 disturbed the fluid in the work area 24, the shielding gases would be drawn away from the work piece and the integrity of the weld would be compromised. By utilizing a sheet-like fluid barrier 52 having a narrow vertical extent 54, this problem is avoided.

The fluid barrier 52 generated by the fluid moving device 48, 50 has a fluid flow rate that is great enough to prevent diffusion of the exhaust gases through the fluid layer. Several variables determine how great the fluid flow rate must be. These variables include the length 38 of the work cell 20, the height 32 of the work cell 20, the temperature of the fluid in the work cell 20, the temperature of the ambient environment of the factory or job site, the temperature of the contaminants such as welding gases, and the density of the contaminants, the amount of contaminants suspended in the fluid, and the size, shape, and power of the fluid filtration unit 42. Accordingly, the fluid moving device 48, 50 of the subject invention must be tailored to produce a fluid barrier 52 having a sufficient fluid flow rate to contain the contaminants.

The fluid moving device 48, 50 of the work cell includes an air blade assembly 48 adjacent the upper wall edge 26 discharging fluid to form the fluid barrier 52 and an inlet 50 adjacent the upper wall edge 26 and spaced downstream, or longitudinally, from the air blade assembly 48 for receiving the fluid and the entrained contaminant from the fluid barrier 52. Accordingly, the fluid barrier 52 extends longitudinally along the length 38 of the work cell 20 between the air blade assembly 48 and the inlet 50 and laterally across the width 40 of the work cell 20. Accordingly, the air blade assembly 48 and the inlet 50 are spaced by a distance 56 which may or may not equal the length 38 of the work cell 20. By way of example only, some exemplary distances 56 between the air blade assembly 48 and the inlet 50 range from four to twenty two feet. Where the work cell 20 has four sides, the air blade assembly 48 is disposed along one of the end walls 36 adjacent the upper wall edge 26. The air blade assembly 48 may further include a plenum 58 and a fan 46 for supplying fluid to the plenum 58. The air blade assembly 48 may have at least one nozzle 60 extending from the plenum 58 for discharging fluid to form the fluid barrier 52 extending across the open top 28.

The at least one nozzle 60 may include a plurality of nozzles 60 disposed along the plenum 58 in a horizontal arrangement. Each nozzle 60 defines a nozzle exit 62 having a tubular shape of a predetermined diameter 64. While the predetermined diameter 64 may vary greatly in size depending on the application, an example of the diameter 64 of the nozzle exit 62 could be in the one inch to one and one half inch range. Alternatively, the nozzle exit 62 may be generally rectangular in shape and much wider than it is tall. This shape of the nozzle exit 62 forms the sheet-like shape of the fluid barrier 52 and creates the narrow vertical extent 54 of the fluid barrier 52. The nozzle exit 62 may also be directed at an upward angle 66 with respect to the horizontal. While a wide variety of angles can be used, an exemplary nozzle exit 62 may be arranged at upward angle 66 of five degrees above the horizontal. Accordingly, the upward angle 66 in combination with the narrow vertical extent 54 of the fluid barrier 52 prevents disturbance of the fluid contained in the work area 24.

The positioning of the nozzles 60, the number of nozzles 60, the number of rows, the size and the pressure of the system are all variables that depend upon the size of the work cell 20. The temperature of the manufacturing operation and the amount of exhaust that is being contained and filtered also affect the nozzle arrangement. These factors also affect the size, shape and power of the fluid filtration unit 42. For example, the length 38 and width 40 of the work cell 20 will require a pre-determined number of nozzles 60, location of the nozzles 60, size of the nozzles 60, and pressures in the plenum 58 as well as the size of the plenum 58. Heat is also a factor. With hotter exhausts, such as those from a welding operation, the exhaust rises faster and can actually break through the fluid barrier 52 created by the nozzles 60. Countering these sizing considerations is the cost of the unit, overall size, etc. The same considerations affect the size of the fluid filtration unit 42.

Another consideration is the broadening and drop-off of the air as it exits the nozzles 60. The angle 66 of the nozzle exit 62 can require adjustment to maintain proper elevation of the fluid barrier 52. With welding operations utilizing shielding gases, the movement of the fluid forming the fluid barrier 52 could adversely affect the shielding gases and the resultant weld quality. To overcome this potential problem, the angle 66 of the nozzle exit 62 is adjusted to keep the fluid barrier 52 in an upper region of the work cell 20 adjacent the open top 28 and away from the work piece. Additionally, the fluid barrier 52 needs to move along the open top 28 of the work cell 20 to draw contaminants such as welding operation exhaust gases in the direction of the fluid filtration unit 42. The contaminants need to be drawn close enough to the fluid filtration unit 42 to be pulled into the unit for filtration.

Where the work cell 20 includes four wall sections, the inlet 50 of the fluid moving device 48, 50 may be disposed along one of the end walls 36 opposite the air blade assembly 48. Accordingly, the fluid barrier 52 extends longitudinally between the end walls 36 and laterally between the side walls 34. The inlet 50 may be connected in fluid communication with the fluid filtration unit 42. Accordingly, the fluid and entrained contaminants received from the fluid barrier 52 by the inlet 50 are communicated to the fluid filtration unit 42 for filtering.

A method for assembling a work cell 20 enclosing a contaminant suspended in a fluid is also provided. The method generally includes the steps of erecting a perimeter wall 22 surrounding and enclosing a work area 24 containing the fluid and the contaminant wherein the perimeter wall 22 includes an upper wall edge 26 defining an open top 28, installing a fluid filtration unit 42 for removing the contaminant from the fluid and returning the fluid to the work area 24, and establishing a sheet-like fluid barrier 52 across the open top 28 of the work cell 20. The fluid barrier 52 is defined by a continuous flow of fluid traveling across the open top 28 for entraining the contaminant and creating a ceiling effect across the open top 28 to prevent escape of the contaminant from the work area 24 through the open top 28. The fluid barrier 52 also has a narrow vertical extent 54 to prevent disturbance of the fluid contained in the work area 24. The step of establishing the sheet-like fluid barrier 52 across the open top 28 of the work cell 20 may further include establishing a fluid flow rate of the fluid barrier 52 great enough to prevent diffusion of the contaminant through the fluid layer. As explained above, many variables determine the necessary fluid flow rate for each specific work cell 20 environment.

The method may further include the step of installing an air blade assembly 48 adjacent the upper wall edge 26 wherein the air blade assembly 48 includes a plenum 58 and a fan 46 for supplying fluid to the plenum 58. At least one nozzle 60 may extend from the plenum 58 for discharging fluid to form the fluid barrier 52 extending across the open top 28. The method may also include the step of installing an inlet 50 adjacent the upper wall edge 26 for receiving the fluid and the entrained contaminant from the fluid barrier 52. The inlet 50 may be installed such that the inlet 50 is longitudinally spaced from the air blade assembly 48 thereby creating the fluid barrier 52 between the air blade assembly 48 and the inlet 50. In accordance with the subject invention, the method may additionally include the step of connecting the inlet 50 to the fluid filtration unit 42 for communicating the fluid and the contaminant from the fluid barrier 52 to the fluid filtration unit 42 for filtering.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A work cell assembly containing a contaminant suspended in a fluid comprising;
a perimeter wall surrounding and enclosing a work area containing the fluid and the contaminant including an upper wall edge defining an open top, and
a fluid moving device establishing a sheet-like fluid barrier extending across said open top defined by a continuous flow of fluid traveling across said open top for entraining the contaminant and creating a ceiling effect across said open top to prevent escape of the contaminant from said work area through said open top wherein said fluid barrier has a narrow vertical extent to prevent disturbance of the fluid contained within said work area.

2. A work cell assembly as set forth in claim 1 wherein said fluid moving device includes an air blade assembly adjacent said upper wall edge discharging fluid to form said fluid barrier and an inlet adjacent said upper wall edge and spaced downstream from said air blade assembly for receiving the fluid and the entrained contaminant from said fluid barrier.

3. A work cell assembly as set forth in claim 2 wherein said fluid barrier extends between said air blade assembly and said inlet.

4. A work cell assembly as set forth in claim 3 further comprising a fluid filtration unit in fluid communication with said inlet for receiving the fluid and the entrained contaminant from the fluid barrier and for removing the entrained contaminant from the fluid.

5. A work cell assembly as set forth in claim 4 wherein said fluid filtration unit includes at least one filter element and a fan for drawing the fluid and the entrained contaminant through said filter element to remove the contaminant from said fluid and for returning said fluid to said work area.

6. A work cell assembly as set forth in claim 5 wherein said air blade assembly includes at least one nozzle for discharging fluid to form said fluid barrier extending across said open top.

7. A work cell assembly as set forth in claim 7 wherein said nozzle exit is directed at an upward angle with respect to the horizontal to prevent disturbance of the fluid contained in said work area.

8. A work cell assembly as set forth in claim 8 wherein said air blade assembly includes a plenum in fluid communication with said nozzle and a fan for supplying a continuous flow of fluid to said plenum and said nozzle.

9. A work cell assembly as set forth in claim 9 wherein said at least one nozzle including a plurality of nozzles of tubular shape disposed along said plenum in a horizontal arrangement.

10. A work cell filtration system as set forth in claim 9 wherein said continuous flow of fluid supplied to said plenum establishes a fluid flow rate in said fluid barrier great enough to prevent diffusion of the contaminant through said fluid layer.

11. A work cell assembly as set forth in claim 11 wherein said perimeter wall is defined by four wall sections including a pair of side walls and a pair of end walls spaced from one another by said side walls.

12. A work cell assembly as set forth in claim 12 wherein said air blade assembly is disposed along one of said end walls and said inlet is disposed along said other end wall opposite said air blade assembly to establish said fluid barrier therebetween.

13. A work cell assembly as set forth in claim 13 wherein the work cell assembly is a welding cell assembly and the contaminant suspended in the fluid is a welding operation exhaust gas suspended in air.

14. A method for assembling a work cell enclosing a contaminant suspended in a fluid comprising the steps of;
erecting a perimeter wall surrounding and enclosing a work area containing the fluid and the contaminant wherein the perimeter wall includes an upper wall edge defining an open top, and
establishing a sheet-like fluid barrier across the open top defined by a continuous flow of fluid traveling across the open top for entraining the contaminant and creating a ceiling effect across the open top to prevent escape of the contaminant from the work area through the open top wherein the fluid barrier has a narrow vertical extent to prevent disturbance of the fluid contained in the work area.

15. A method for assembling a work cell as set forth in claim 15 further comprising the steps of:
installing an air blade assembly adjacent the upper wall edge for discharging fluid to form the fluid barrier extending across the open top, and
installing an inlet adjacent the upper wall edge and spaced downstream from the air blade assembly for receiving the fluid and the entrained contaminant from the fluid barrier extending from the air blade assembly to the inlet.

16. A method for assembling a work cell as set forth in claim 16 further comprising the step of:
installing a fluid filtration unit in fluid communication with the inlet for removing the contaminant from the fluid before returning the fluid to the work area.

17. A method for assembling a work cell as set forth in claim 17 further comprising the step of:
establishing a great enough fluid flow rate of the fluid barrier to prevent diffusion of the contaminant through said fluid layer.

18. A method for assembling a work cell as set forth in claim 18 wherein the work cell assembly is a welding cell and the contaminant suspended in the fluid is a welding operation exhaust gas suspended in air.
